(19) United States
(12) Patent Application Publication
(10) Pub. No.: US 2009/0158785 A1
(43) Pub. Date: Jun. 25, 2009

(54) Dispenser

(75) Inventor: Phil Keem, Victoria (AU)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofdorp (NL)

(21) Appl. No.: 12/295,903

(22) PCT Filed: Apr. 5, 2007
(86) PCT No.: PCT/GB07/01267

§ 371 Date: Oct. 3, 2008

(30) Foreign Application Priority Data
Apr. 6, 2006 (GB) 0606910.8

(51) Int. Cl. D06F 35/00; B67D 5/64

(52) U.S. Cl. 68/17 R; 222/463

(57) ABSTRACT

A dispenser for a liquid detergent composition suitable for use in an automatic washing machine having a rotating drum, comprises a housing including a reservoir for the detergent composition. The reservoir has a dispensing aperture. The dispenser includes a weight which is moveable relative to the housing. The movement of the weight is driven by rotation of the drum. The weight is connected to a closure for the dispensing aperture. Movement of the weight causes the dispensing aperture to open.

The invention relates to a dispenser, more particularly to a dispenser for a detergent composition.

During a laundry washing process different detergent compositions are used. The different compositions provide specialised functions for distinct parts of the washing cycle. Normally the laundry washing machine acknowledges this requirement and has a detergent dosing system which takes this into account (e.g. a multi-compartment drawer) wherein the individual drawer compartments are intended to contain/dose certain detergent components.

However, not all laundry washing machines have this capability, particularly some top-loading machines.

For top-loading machines where this capability is not present, of all the different detergent compositions, it is very inconvenient to dose detergent formulations in the rinse cycle. This is because consumers have to wait until the rinse phase starts, interrupt the cycle, open the machine, manually add detergent, close the machine and restart the cycle.

Various dispensing devices have been developed and are present in the market to address this issue, as described for example in U.S. Pat. No. 3,108,722 or in U.S. Pat. No. 6,681,963.

Whilst the devices described in these documents partially address the problem they have a relatively complex structure, consisting of various detachable pieces, therefore are easy to break and/or to lose parts.

Moreover the devices still require a tedious sequence of actions to operate them (e.g. extract from washing machine, fill, close, insert in washing machine) and in particular a filling operation where annoying spillages can easily occur.

It is an object of the present invention to obviate/mitigate the issues outlined above.

According to a first aspect of the present invention there is provided a dispenser for a liquid detergent composition suitable for use in an automatic washing machine having a rotating drum, comprising a housing including a reservoir for the detergent composition, the reservoir having a dispensing aperture, the dispenser including a weight which is moveable relative to the housing, the movement of the weight being driven by rotation of the drum, the weight being connected to a closure for the dispensing aperture, such that movement of the weight causes the dispensing aperture to open.

We have found that the dispenser is particularly advantageous because the device is capable of effective dosing of detergent to an automatic washing machine having a rotating drum. Additionally the device has no loose parts. Thus not only does the device not have any elements that can be lost or misplaced by a consumer but also there are no elements that can work themselves loose from the device and interfere with the operation of the washing machine. Moreover the amount of input required by a consumer is minimal.

Generally the dispenser is for use in an automatic laundry washing machine.

There are two main types of automatic laundry machine; the top-loading type (most common in the United States—and Korea) and the front loading type (most common in Europe). Generally the dispenser is for use in a top-loading washing machine.

Generally the weight comprises a portion of the housing of the dispenser, e.g. a portion of a surface of the housing. It is preferred that the weight comprises an central/inner portion of the housing. The portion of the housing forming the weight portion may be thicker than the remainder of the housing.

The closure generally comprises a portion of the housing, e.g. a portion of a surface of the housing. It is preferred that the closure comprises an edge/peripheral portion of the housing. Here it will be appreciated that as the dispenser is not necessarily attached to the drum of the machine it is preferred that the dispenser either has a plurality of closures arranged around its circumference. Alternatively the dispenser may have a single closure which extends all the way around it circumference to achieve this aim. It is expected that the lowermost closure/lowermost part of the closure is expected to dispense the bulk of the detergent.

Usually the portion of the housing which comprises the weight and the portion the housing which comprises the closure are adjacent.

It is preferred that the weight and the closure are connected about a pivot. Thus movement of the weight in one direction causes movement of the closure in an opposite direction. It is appreciated that with increasing drum revolution speed the weight is driven towards the drum. Thus it is preferred that the pivot is in a plane parallel to the circumference of the drum (on a concentric circle inside the drum). In this way as the weight is driven towards the drum the closure is driven away from the drum, thus opening the dispensing aperture.

Generally there is a gap between the closure portion and the weight portion. This gap preferably comprises the pivot. Preferably the gap comprises a weakened portion of the housing. In this way the weight portion and the closure portion, whilst being supported by the remainder of the housing, are able to move (about the pivot) relative to the remainder of the housing.

The gap may be weakened by making the gap portion of the housing thinner than the remainder of the housing (e.g. by have a recess in a surface of the housing forming the gap). The gap portion may be angled (e.g. towards the interior of the dispenser) to form a more defined pivot.

Preferably the housing comprises an internal frame. The internal frame may be used to provide support to the pivot between the weight and the closure to facilitate the operation of the pivot.

The dispenser is preferably intended to dispense its contents in a single wash cycle. That said it is preferred that the dispenser may be refilled by a user. Most preferably the refilling means compositing a suitable refilling aperture through which additional detergent composition may be added (e.g. from a suitable bottle). To aid the user in knowing when there is a need to add more detergent composition/when the detergent composition has been dispensed preferably the dispenser comprises a transparent/translucent section to view the reservoir contents. The transparent/translucent section thus preferably acts as a “window”.

Preferably the contents of the dispenser are discharged when the drum of the machine is spinning. Most preferably the aperture is opened when the machine is spinning at a relatively high speed, such as between the wash cycle(s) and the rinse cycle(s) (e.g. at or above 200 rpm).

Thus preferably the detergent formulation is one which is useful in the rinse phase of the wash cycle. Such formulations generally provide one or more benefits such as softness, wrinkle reduction, stain repellancy. Generally such formulations contain actives such as cationic surfactants, silicones, aminoamides, and/or fluoropolymers.

According to a second aspect of the invention there is provided the use of a dispenser for a liquid detergent composition suitable for use in an automatic washing machine having a rotating drum, comprising a housing including a reservoir for the detergent composition, the reservoir having a dispensing aperture, the dispenser including a weight which is moveable relative to the housing, the movement of the weight being driven by rotation of the drum, the weight being connected to a closure for the dispensing aperture, such that movement of the weight causes the dispensing aperture to open.

According to a third aspect of the invention there is provided a method of laundering clothes comprising the use of a dispenser for a liquid detergent composition suitable for use in an automatic washing machine having a rotating drum, comprising a housing including a reservoir for the detergent composition, the reservoir having a dispensing aperture, the dispenser including a weight which is moveable relative to the housing, the movement of the weight being driven by rotation of the drum, the weight being connected to a closure for the dispensing aperture, such that movement of the weight causes the dispensing aperture to open.

Preferably the dispenser comprises a plastics material such as polypropylene.

The invention will now be described with reference to the following Figures, in which:—

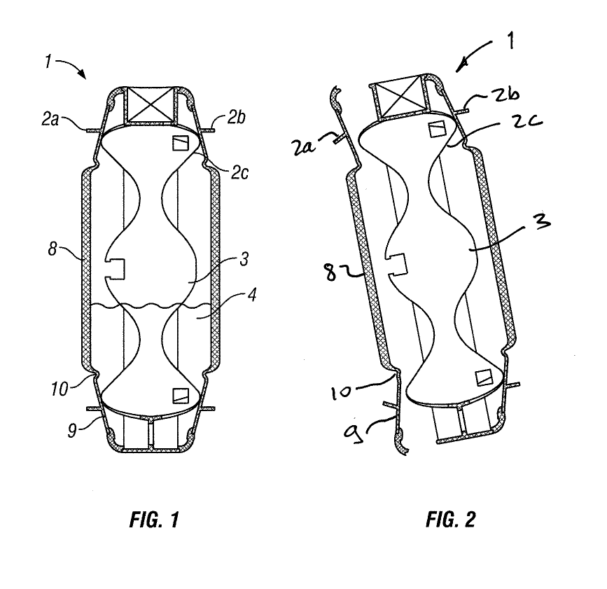

FIG. 1 is an cross-sectional view of a dispenser according to the present invention in a closed position;

FIG. 2 is a cross-sectional view of a dispenser according to the present invention in an open position; and

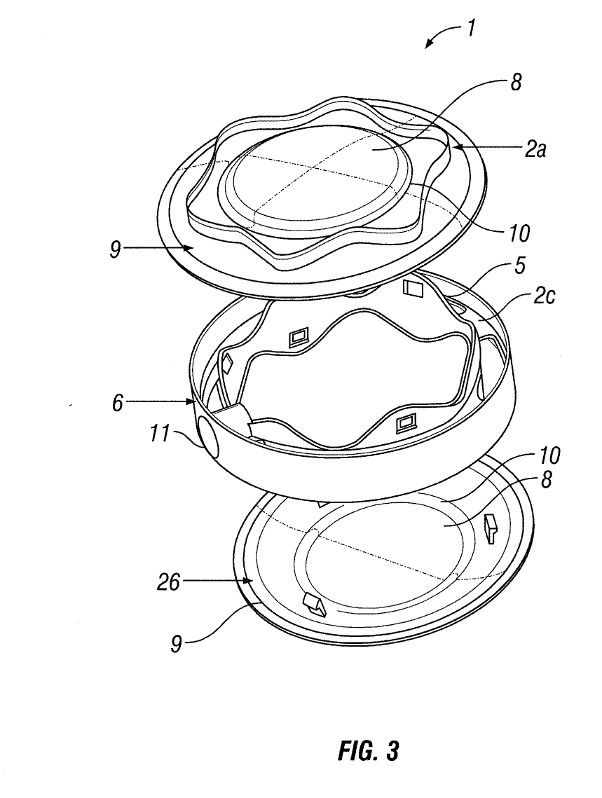

FIG. 3 is a perspective view of an exploded dispenser according to the present invention.

In the Figures it can be seen that the dispenser 1 comprises a housing 2 in three parts. The housing 2 comprises two covers 2a, 2b and an inner frame 2c. The covers 2a, 2b are attached to the inner frame 2c in a “snapfit” fashion to form a reservoir 3 which holds a volume of detergent composition 4.

The inner frame 2c comprises two joined concentric rings 5 and 6.

The covers 2a, 2b comprise a central weight portion 8 and a peripheral closure portion 9. The weight portion 8 is thicker than the closure portion 9. Between the weight portion 8 and the closure portion 9 there is a weakened (e.g. by thinning) pivot portion 10 therebetween.

As assembled the closure portion 9 of the covers 2a, 2b abut against the outer ring 6 of the inner frame 2c, thus sealing the reservoir 3. The pivot portion 10 is disposed adjacent the inner ring 5 of the inner frame 2c.

In use the housing 2 holds the reservoir 3 in place adjacent the drum of a washing machine (not shown). The cover 2a (which in use is mounted furthest away from the drum of the washing machine) includes a window (not shown) so that a user can view the contents of the reservoir 3. The outer ring 6 of the inner frame 2c includes a filling aperture 11 for filling the reservoir 3.

The dispenser 1 may already contain a volume of detergent or may be filled via the filling aperture.

When the drum of the washing machine is spinning at a certain speed (e.g. above 200 rpm) the weight portion 8 of the cover 2a is forced towards the drum of the machine. In doing so the weight portion 8 is moved towards the drum. The pivot portion 10 is supported by the inner frame 2c. With the support of the pivot 10 and the movement of the weight portion 8 the closure portion 9 is caused to be moved away from the drum of the machine and thus the reservoir 3 is opened allowing dispense of the detergent composition 4 from the dispenser 1.

These Figures should only be taken as illustrating one embodiment of a device in accordance with the invention and should not be taken as being limiting in any way.

The invention is now further described with reference to the following non-limiting Examples.

### EXAMPLES

In the Examples a device according to the Figures was produced and filled with a cleaning composition intended to be discharged in the final rinse stage of a top-loader washing machine (Whirlpool Ultimate Care II).

The weight of the device including the cleaning composition was taken at various stages of a permanent press washing cycle for two dosage levels.

Permanent Press Washing Cycle
Detergent Dose

| | |
|---|---|
| 30 g | 90 g |

Weight of liquid inside the device

| | | |
|---|---|---|
| start wash | 31 | 95 |
| ½ main | 32 | 105 |
| end | 39 | 107 |
| main/start | | |
| spin | | |
| end spin/ | 11 | 8 |
| start rinse | | |
| end | 16 | 7 |
| rinse/start | | |
| low spin | | |
| end wash | 12 | 3 |

During main wash the device's weight increases due to water intrusion. The liquid is released at the end of the spin cycle.

1. A dispenser adapted for use in an automatic washing machine having a rotating drum for delivering a liquid detergent composition, comprising:
a housing including a reservoir for the detergent composition, the reservoir having a dispensing aperture, the dispenser including a weight which is moveable relative to the housing, the movement of the weight being driven by rotation of the drum, the weight being connected to a closure for the dispensing aperture, such that movement of the weight causes the dispensing aperture to open.

2. A dispenser according to claim 1, wherein the dispenser is adapted for use in a laundry washing machine.

3. A dispenser according to claim 2, wherein the dispenser is adapted for use in a top-loading washing machine.

4. A dispenser according to claim 1 wherein the weight is a portion of the housing of the dispenser.

5. A dispenser according to claim 1 wherein the closure is a portion of the housing of the dispenser.

6. A dispenser according to claim 5, wherein the dispenser has a plurality of closures.

7. A dispenser according to claim 5, wherein the dispenser has a single closure which extends all the way around its circumference.

8. A dispenser according to claim 1, wherein the weight and the closure are connected about a pivot.

9. A dispenser according to claim 1, wherein a portion of the housing of the dispenser between the closure and the weight is weakened.

10. A dispenser according to claim 1, claims, wherein the housing comprises an internal frame.

11. A dispenser according to claim 10, wherein the internal frame supports the weakened portion of the housing.

12. A dispenser according to claim 1, wherein the dispenser can be re-filled.

13. A dispenser according to claim 1, wherein the dispenser comprises a transparent/translucent section to view the reservoir contents.

14. (canceled)

15. A method of laundering clothes in an automatic washing machine having a rotating drum, which method comprises the step of:
providing and utilizing dispenser for a liquid detergent composition according to claim 1 during the process of laundering clothes in the automatic washing machine.
